(19) United States
(12) Patent Application Publication
(10) Pub. No.: US 2011/0297248 A1
(43) Pub. Date: Dec. 8, 2011

(54) FAUCET MANIFOLD

(75) Inventors: Alfred C. Nelson, Westfield, IN (US); Dewayne Davis, Lebanon, IN (US)

(73) Assignees: Mercury Plastics, Inc., Middlefield, OH (US); Masco Corporation of Indiana, Indianapolis, IN (US)

(21) Appl. No.: 13/201,965

(22) PCT Filed: Feb. 26, 2010
(86) PCT No.: PCT/US10/25524

§ 371 Date: Aug. 17, 2011

Related U.S. Application Data
(60) Provisional application No. 61/156,191, filed on Feb. 27, 2009.

(51) Int. Cl. F16L 3/00; F15D 1/00; F16K 51/00

(52) U.S. Cl. 137/343; 137/801; 137/561 R

(57) ABSTRACT

A faucet including a molded waterway assembly having a plurality of tubes and nipples overmolded within a collar.

### BACKGROUND AND SUMMARY OF THE INVENTION

The present invention relates generally to plumbing fixtures and, more particularly, to a faucet including a molded waterway assembly.

Single handle faucets typically include mixing valves that control the flow of both hot and cold water to a delivery spout. These faucets have found wide acceptance and are commonly constructed such that a handle or knob is movable in distinct directions to adjust the temperature of outlet water, by controlling the mixture of hot and cold inlet water, and to adjust the flow rate of the mixed outlet water.

Conventional mixing valves typically include a machined brass body and associated brass fittings. The brass body usually includes a hot water inlet, a cold water inlet, and a mixed water outlet. An adjustable valve element, typically either a mixing ball or a slidable plate, is manipulated by a handle to control the aforementioned temperature and flow rate of water. In conventional faucets, copper tubes are usually brazed to the inlets and the outlet(s) of the valve body and to associated fittings. Following the brazing operation, an etching or bright dip operation is typically performed to clean the metal surfaces of contaminants.

It may be appreciated that such conventional mixing valves have certain disadvantages. For example, the cost of copper tubing and the additional assembly cost associated with the brazing and bright dipping operations may be significant. The bright dipping operation may also result in the undesirable deposit of metal on the valve body. As such, it is known that the use of polymeric materials for waterways may reduce cost, eliminate metal contact, and provide protection against acidic and other aggressive water conditions. The use of non-metallic materials in plumbing fixtures is significant given the growing concern about the quality of potable water. The U.S. Environmental Protection Agency (EPA), National Sanitary Foundation (NSF) International, and other health-related organizations, are actively seeking to reduce the amount of metal, such as copper and lead, in water.

Previous non-metallic faucets have often attempted to use plastic in a method similar to brass—as both a structural component and a water conducting mechanism. Such faucets may cause certain issues because the yield strength and stiffness of most plastics are not similar to the properties of brass. Higher grade materials that may be suitable for structural applications can be difficult to process, so materials less suitable for structural applications may be used in the interest of cost and long term durability.

According to an illustrative embodiment of the present disclosure, a fluid delivery device includes a waterway assembly and a valve assembly. The waterway assembly includes an inlet fluid transport component formed of a polymer and extending between opposing first and second ends, an inlet nipple formed of a polymer and fluidly coupled to the second end of the inlet fluid transport component, an outlet fluid transport component formed of a polymer and extending between opposing first and second ends, an outlet nipple formed of a polymer and fluidly coupled to the second end of the outlet fluid transport component, and a collar formed of a polymer and having an upper surface and a lower surface, the collar being overmolded around the inlet fluid transport component, the inlet nipple, the outlet fluid transport component, and the outlet nipple. The valve assembly includes an inlet port in fluid communication with the inlet nipple, an outlet port in fluid communication with the outlet nipple, and a movable valve member configured to control the flow of water from the inlet port to the outlet port.

According to another illustrative embodiment of the present disclosure, a faucet includes a hub, a waterway assembly fluidly coupled to the hub, and a valve assembly fluidly coupled to the hub. The waterway assembly includes a non-metallic collar, a non-metallic hot water inlet tube having a first end configured to be fluidly coupled to a hot water supply and a second end operably coupled to the collar, a non-metallic hot water inlet nipple fluidly coupled to the second end of the hot water inlet tube, a non-metallic cold water inlet tube having a first end configured to be fluidly coupled to a cold water supply and a second end operably coupled to the collar, a non-metallic cold water inlet nipple fluidly coupled to the second end of the cold water inlet tube, a non-metallic outlet tube extending between opposing first and second ends, the second end operably coupled to the collar, and a non-metallic outlet nipple fluidly coupled to the second end of the outlet tube. The valve assembly includes a hot water inlet port in fluid communication with the hot water inlet nipple, a cold water inlet port in fluid communication with the cold water inlet nipple, an outlet port in fluid communication with the outlet nipple, and a movable valve member configured to control the flow of water from the hot water inlet port and the cold water inlet port to the outlet port.

According to yet another illustrative embodiment of the present disclosure, a waterway assembly includes a plurality of tubes formed of a polymer and extending between opposing first and second ends, a plurality of nipples formed of a polymer and fluidly coupled to the second ends of the plurality of tubes, and a collar formed of a polymer and having an upper surface and a lower surface, the collar being overmolded around the second ends of the plurality of tubes and the plurality of nipples.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of an illustrative embodiment faucet of the present disclosure mounted to a sink deck;

FIG. 2 is an exploded perspective view of the faucet of FIG. 1;

FIG. 3 is a top plan view of the faucet of FIG. 1;

FIG. 4 is a cross-sectional view of the faucet of FIG. 3, taken along line 4-4 of FIG. 3;

FIG. 5 is a cross-sectional view of the faucet of FIG. 3, taken along line 5-5 of FIG. 3;

FIG. 6 is a cross-sectional view of the faucet of FIG. 3, taken along line 6-6 of FIG. 3;

FIG. 7 is an exploded perspective view of a hub and a waterway assembly of the faucet of FIG. 1;

FIG. 8 is a right side perspective view of the waterway assembly of FIG. 7;

FIG. 9 is a left side elevational view of the waterway assembly of FIG. 8;

FIG. 10 is a right side elevational view of the waterway assembly of FIG. 8;

FIG. 11 is a front elevational view of the waterway assembly of FIG. 8;

FIG. 12 is a rear elevational view of the waterway assembly of FIG. 8;

FIG. 13 is a top plan view of the waterway assembly of FIG. 8;

FIG. 14 is a bottom plan view of the waterway assembly of FIG. 8; and

FIG. 15 is an exploded perspective view of the hub and a valve body of the faucet of FIG. 1.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention. Although the disclosure is described in connection with water, it should be understood that additional types of fluids may be used.

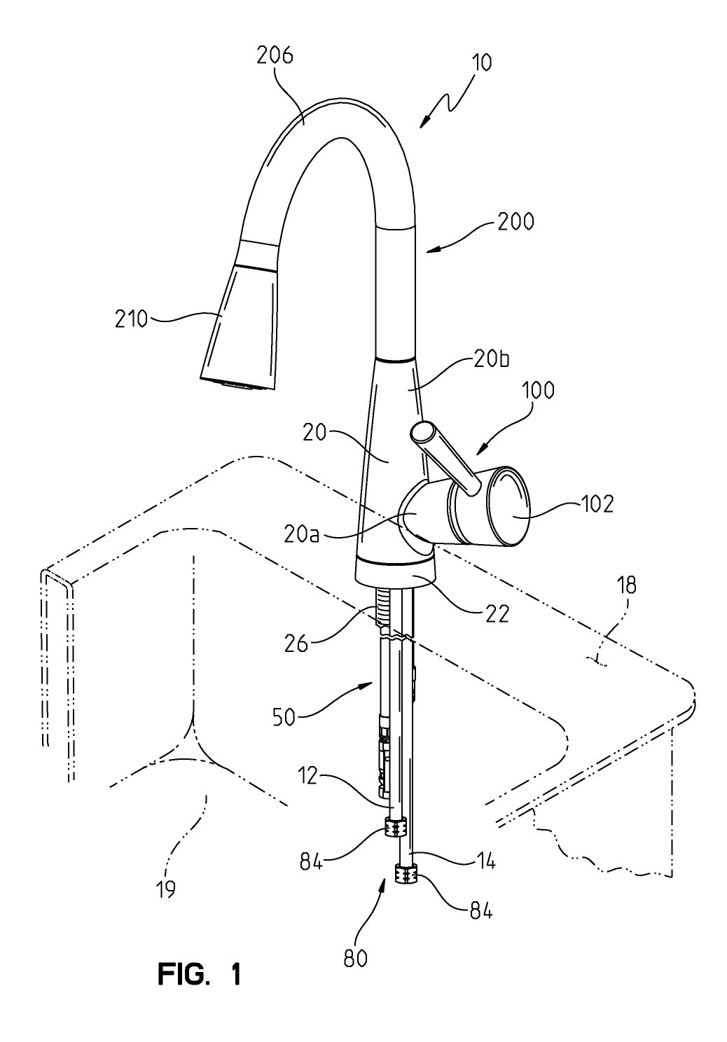

Referring initially to FIG. 1, an illustrative embodiment faucet 10 is shown. In operation, faucet 10 is fluidly coupled to hot and cold water supplies (not shown). For example, faucet 10 of FIG. 1 includes hot water inlet tube 12 and cold water inlet tube 14 configured to fluidly couple faucet 10 to hot and cold water supplies, respectively. Faucet 10 may be mounted to sink deck 18 or another suitable surface to receive and mix the incoming water from the hot and cold water supplies into an outlet stream. Then, faucet 10 may deliver that outlet stream into sink basin 19, for example.

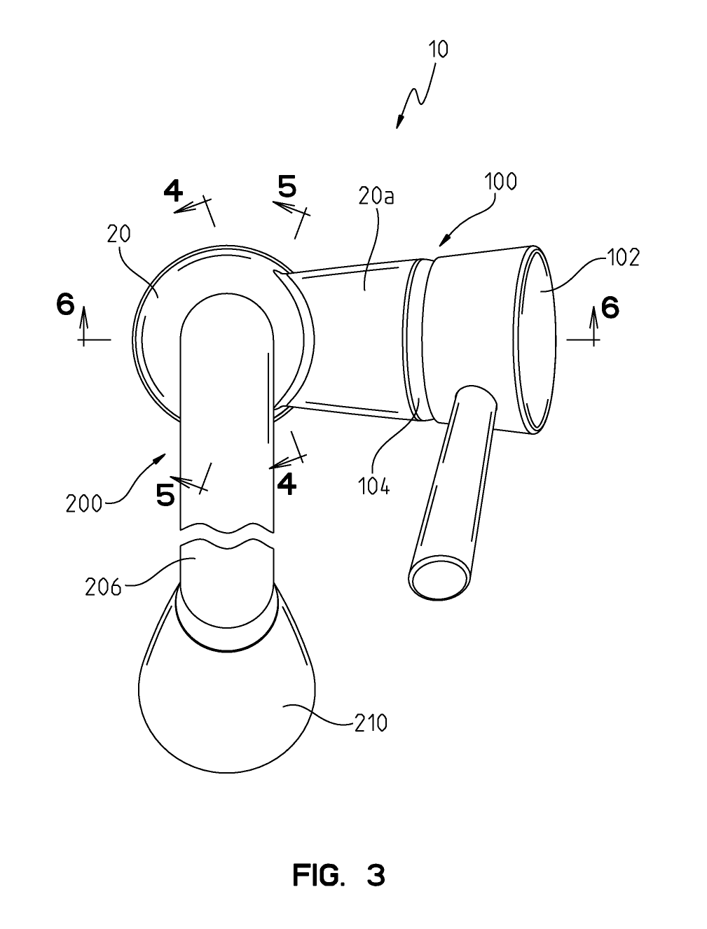

With reference to FIGS. 1-3, faucet 10 illustratively includes hub 20, base 22, sealing gasket 24, and threaded, downwardly extending mounting shank 26. Hub 20 of faucet 10 may include valve portion 20a and spout portion 20b. Further, hub 20 may define internal chamber 21 extending within valve portion 20a and spout portion 20b. Mounting shank 26 may extend into chamber 21 of hub 20 and may be secured within hub 20 using a threaded engagement, a suitable fastener, or an adhesive, for example. With hub 20, base 22, and sealing gasket 24 positioned above sink deck 18, mounting shank 26 extends beneath sink deck 18. To secure faucet 10 in place, bracket 30 may be tightened beneath sink deck 18 by securing nut 32, and, optionally, spacer 34, to mounting shank 26, for example.

In one illustrative embodiment, hub 20 of faucet 10 is formed of a non-metallic material. More particularly, hub 20 of faucet 10 may be molded from a polymer, such as a thermoplastic or a cross-linkable material, and illustratively a cross-linkable polyethylene (PEX). Further illustrative non-metallic materials include polybutylene terephthalate (PBT) and thermosets, such as polyesters, melamine, melamine urea, melamine phenolic, and phenolic. It is also within the scope of the present disclosure that hub 20 of faucet 10 may be formed of a traditional metallic material, such as zinc or brass.

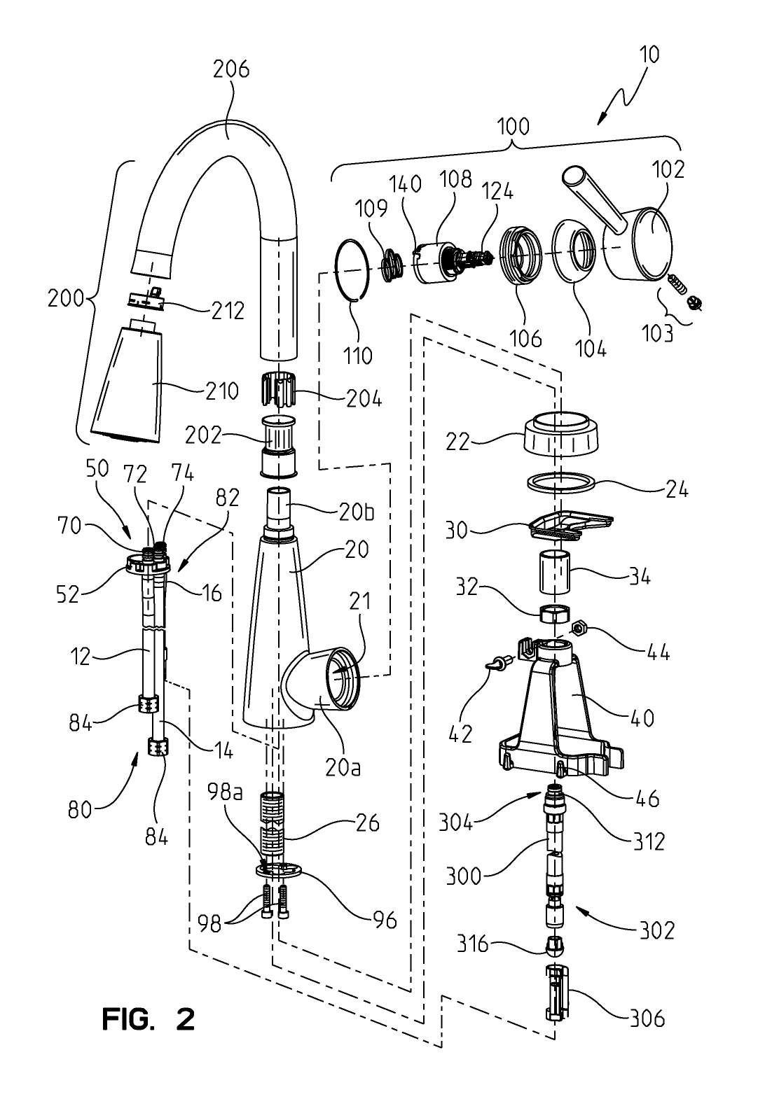

Optionally, faucet 10 may include bag holder 40, as shown in FIG. 2. In the illustrated embodiment, bag holder 40 may be clamped onto mounting shank 26, beneath bracket 30 and nut 32, using thumb screw 42 and nut 44. Bag holder 40 may also be threaded onto mounting shank 26 or otherwise secured in place. Bag holder 40 includes a plurality of hooks 46, upon which a bag (not shown) may be hung to store tools and to protect and organize under-sink components of faucet 10. For example, the bag may prevent outlet hose 300, which is described below, from becoming tangled with other under-sink components of faucet 10.

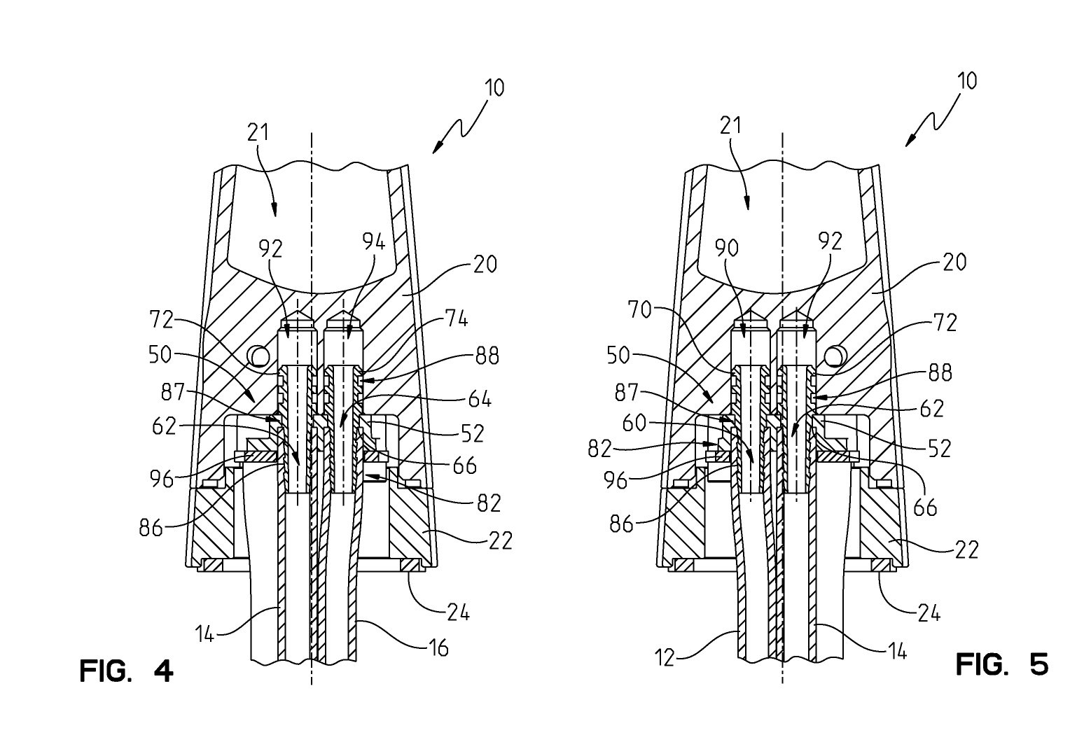

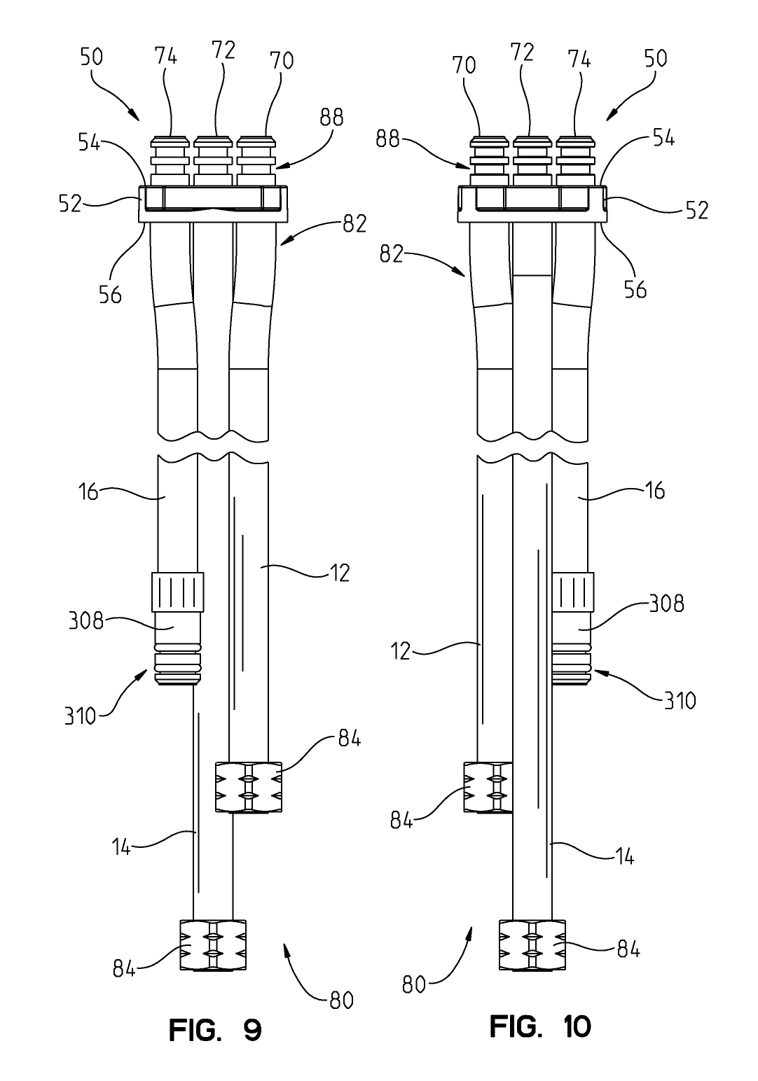

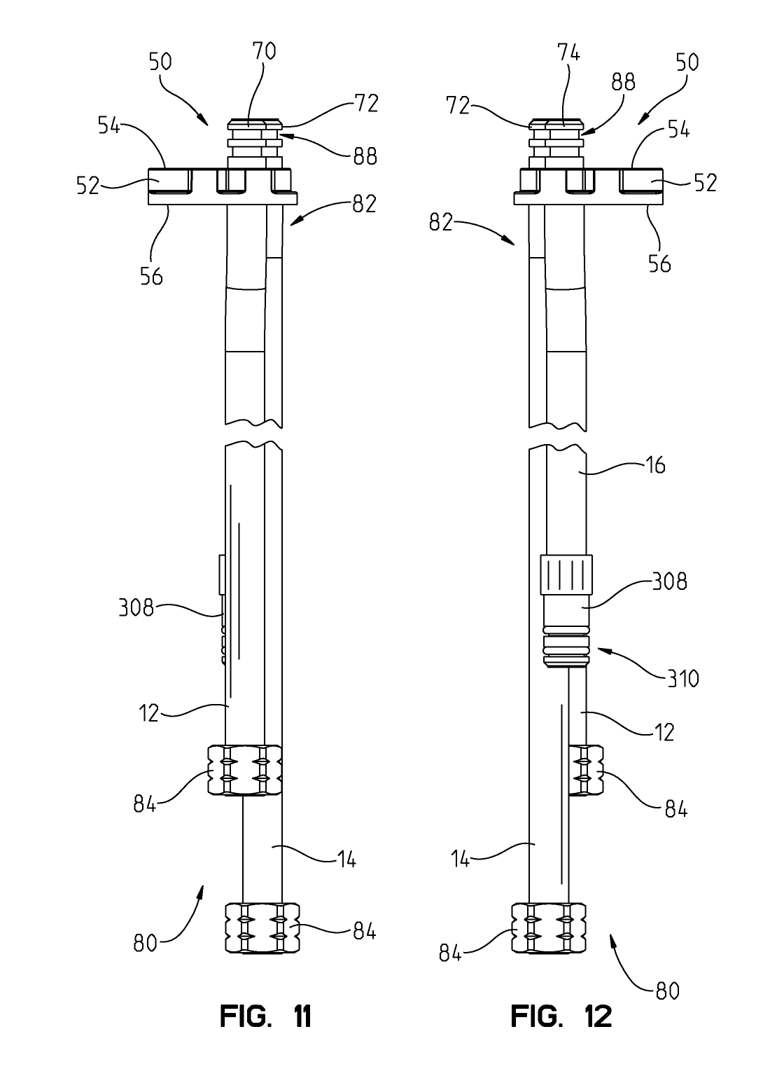

With reference to FIGS. 4-14, faucet 10 further includes a waterway assembly 50. Waterway assembly 50 includes hot water inlet tube 12, cold water inlet tube 14, and outlet tube 16. Hot water inlet tube 12, cold water inlet tube 14, and outlet tube 16, each extend between first end 80 and an opposite second end 82. As discussed above, hot water inlet tube 12 and cold water inlet tube 14 are configured to fluidly couple to hot and cold water supplies (not shown), respectively. For example, first ends 80 of hot and cold water inlet tubes 12, 14, may include conventional fluid couplings having internally threaded nuts 84 that are configured to fluidly couple hot and cold inlet tubes 12, 14, to hot and cold water supplies, such as hot and cold water stops, respectively.

In an illustrative embodiment, tubes 12, 14, 16, may include certain additional features, such as corrugated walls for improved flexibility, as detailed in U.S. Patent Publication No. 2008/0178957 to Thomas et al., filed Jan. 31, 2007, entitled “TUBE ASSEMBLY,” the disclosure of which is expressly incorporated by reference herein.

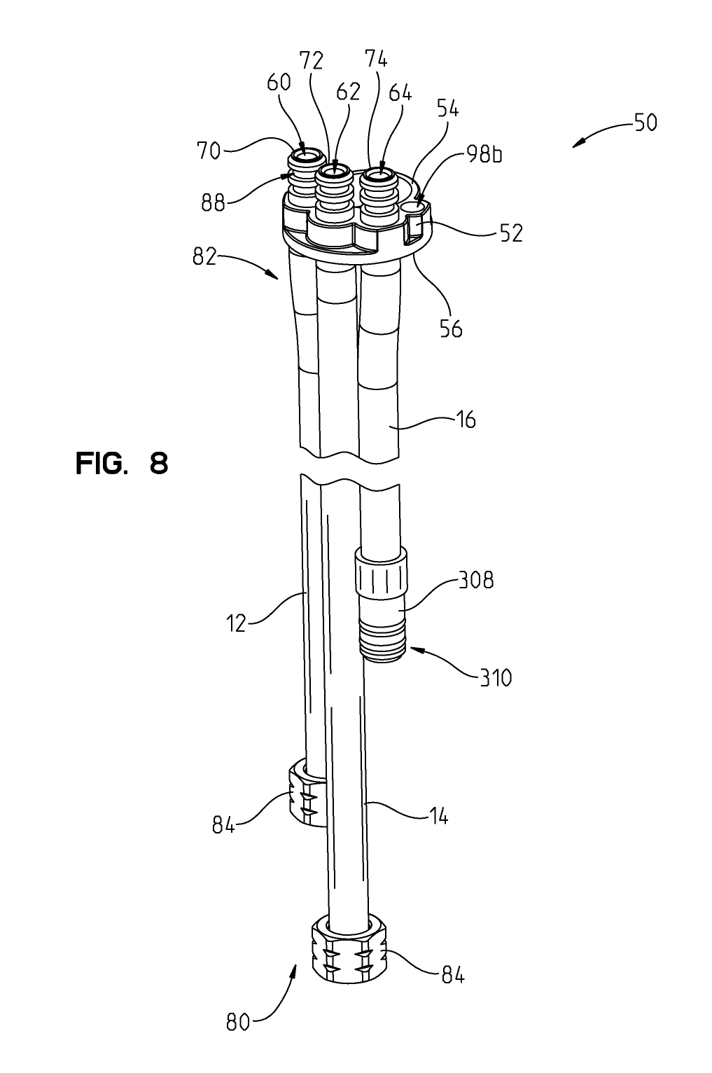

Waterway assembly 50 also includes a disk-shaped body or collar 52 having upper surface 54 and lower surface 56. Collar 52 includes a hot water inlet opening 60, a cold water inlet opening 62, and an outlet opening 64, each opening 60, 62, 64, extending entirely through collar 52 from upper surface 54 to lower surface 56. As shown in FIGS. 4-6, hot water inlet tube 12, cold water inlet tube 14, and outlet tube 16, are fluidly coupled to collar 52. More particularly, second ends 82 of tubes 12, 14, 16, are received in openings 60, 62, 64, of collar 52, respectively. As shown in FIG. 8, second ends 82 of tubes 12, 14, 16, are arranged in a generally triangular pattern to, for example, reduce the required size of collar 52, although it is within the scope of the present disclosure that second ends 82 of tubes 12, 14, 16, may be aligned in a linear pattern or another suitable pattern. With second ends 82 of tubes 12, 14, 16, positioned within openings 60, 62, 64, collar 52 surrounds and supports tubes 12, 14, 16, that extend substantially in parallel beneath lower surface 56 of collar 52. In the illustrated embodiment of FIGS. 4-6, each opening 60, 62, 64, of collar 52 is counterbored from lower surface 56 upwardly toward upper surface 54 to define shoulder 66. Shoulders 66 of collar 52 cooperate with second ends 82 of tubes 12, 14, 16, to prevent tubes 12, 14, 16, from retracting upward into hub 20 under pressure.

Waterway assembly 50 further includes hot water inlet nipple 70, cold water inlet nipple 72, and outlet nipple 74. As shown in FIGS. 4-6, hot water inlet nipple 70 is fluidly coupled to hot water inlet tube 12, cold water inlet nipple 72 is fluidly coupled to cold water inlet tube 14, and outlet nipple 74 is fluidly coupled to outlet tube 16. More particularly, nipples 70, 72, 74, are fluidly coupled to second ends 82 of tubes 12, 14, 16, respectively. With nipples 70, 72, 74, positioned within tubes 12, 14, 16, and with tubes 12, 14, 16, positioned within openings 60, 62, 64, collar 52 surrounds and supports nipples 70, 72, 74, that extend substantially in parallel above upper surface 54 of collar 52. More particularly, collar 52 extends into annular recess 87 of each nipple 70, 72, 74, as shown in FIGS. 4-6.

Waterway assembly 50 may be formed of a flexible, non-metallic material, such as a polymer. According to an exemplary embodiment of the present disclosure, tubes 12, 14, 16, collar 52, and nipples 70, 72, 74, of waterway assembly 50, are formed of compatible materials, such as polymers, and illustratively of cross-linkable materials. As such, waterway assembly 50 is illustratively electrically non-conductive. As used within this disclosure, a cross-linkable material illustratively includes thermoplastics and mixtures of thermoplastics and thermosets. In one illustrative embodiment, waterway assembly 50, and more particularly tubes 12, 14, 16, collar 52, and nipples 70, 72, 74, of waterway assembly 50, are formed of a polyethylene which is subsequently cross-linked to form cross-linked polyethylene (PEX). It is within the scope of the present disclosure that the polyethylene material for waterway assembly 50 may include reinforcing members, such as glass fibers. It should also be appreciated that other polymers may be substituted for polyethylene. For example, waterway assembly 50 may be formed of any polyethylene (PE) (such as raised temperature resistant polyethylene (PE-RT)), of polypropylene (PP) (such as polypropylene random (PPR)), or of polybutylene (PB). It is further envisioned that waterway assembly 50 may be formed of cross-linked polyvinyl chloride (PVCX) using silane free radical initiators, of cross-linked polyurethane, or of cross-linked propylene (XLPP) using peroxide or silane free radical initiators.

An illustrative method of manufacturing waterway assembly 50 involves fluidly coupling individual tubes 12, 14, 16, to corresponding nipples 70, 72, 74. More particularly, the illustrative method involves fluidly coupling second end 82 of hot water inlet tube 12 to hot water inlet nipple 70, second end 82 of cold water inlet tube 14 to cold water inlet nipple 72, and second end 82 of outlet tube 16 to outlet nipple 74. As shown in FIGS. 4-6, nipples 70, 72, 74, may be inserted into second ends 82 of tubes 12, 14, 16, respectively. For example, nipples 70, 72, 74, may include barbs 86, to enhance the grip to tubes 12, 14, 16. Nipples 70, 72, 74, may also include external threads, flanges, or ridges, to enhance the grip to tubes 12, 14, 16.

The illustrative method also involves fluidly coupling tubes 12, 14, 16, and nipples 70, 72, 74, to collar 52. For example, the illustrative method involves overmolding collar 52 around second ends 82 of previously assembled tubes 12, 14, 16, and nipples 70, 72, 74. In other words, collar 52 may be molded over tubes 12, 14, 16, having nipples 70, 72, 74, already inserted therein, in the manner detailed below. Overmolding collar 52 partially melts tubes 12, 14, 16, and nipples 70, 72, 74, to form material-to-material couplings or bonds between the components. Therefore, a substantially leak-proof coupling may be achieved between tubes 12, 14, 16, nipples 70, 72, 74, and collar 52. It is also within the scope of the present disclosure that tubes 12, 14, 16, and nipples 70, 72, 74, may be fluidly coupled to collar 52 by other methods including ultrasonic welding or heat staking, for example.

According to an exemplary embodiment of the present disclosure, second ends 82 of tubes 12, 14, 16, are illustratively positioned within a mold (not shown). Pins or mandrels, for example, slide into second ends 82 of each tube 12, 14, 16, and each corresponding nipple 70, 72, 74, to prevent collapsing thereof during the injection molding process. The mold then receives a flowable polymer, illustratively polyethylene, to form collar 52 therein. Second ends 82 of tubes 12, 14, 16, partially melt and bond with the overmolded material of collar 52. Also, the flowable polymer flows into annular recess 87 defined by each nipple 70, 72, 74, and partially melts nipples 70, 72, 74, as shown in FIGS. 4-6. After the polymer sufficiently hardens, the mold is opened to release a substantially monolithic waterway assembly 50, including collar 52, tubes 12, 14, 16, and nipples 70, 72, 74. The illustrative method may facilitate assembly of waterway assembly 50 by permitting nipples 70, 72, 74, to be inserted into tubes 12, 14, 16, prior to overmolding.

Exemplary overmolding processes are described in U.S. Patent Publication No. 2007/0271695 to Thomas et al., filed Jan. 31, 2007, entitled “FAUCET INCLUDING A MOLDED WATERWAY ASSEMBLY,” and U.S. Patent Publication No. 2008/0178950 to Marty et al., filed Jan. 31, 2007, entitled “MIXING VALVE INCLUDING A MOLDED WATERWAY ASSEMBLY,” the disclosures of which are expressly incorporated by reference herein. Other exemplary overmolds are shown and described in U.S. Pat. No. 5,895,695, U.S. Pat. No. 6,082,780, U.S. Pat. No. 6,287,501, and U.S. Pat. No. 6,902,210, each listing William W. Rowley as an inventor, the disclosures of which are all expressly incorporated by reference herein.

The illustrative method further involves cross-linking the overmolded waterway assembly 50. For example, a flexible, or semi-rigid, waterway assembly 50 constructed of polyethylene may be cross-linked to form a PEX waterway assembly 50. Cross-linking polyethylene couples the individual molecule chains together and may prevent splitting. While a polymer, such as cross-linkable polyethylene, is the illustrative material for waterway assembly 50, including collar 52 of waterway assembly 50, in certain embodiments, other materials may be substituted therefore, such as brass or copper.

Curing or cross-linking processes typically utilize a catalyst that causes a polymer to crosslink when a certain temperature, pressure, and/or humidity is achieved, such as in a hot bath. Curing or cross-linking processes may utilize one or a combination of technologies to form, for example, PEX-A, PEX-B, or PEX-C. PEX-A is formed by using peroxide to cross-link polyethylene. More particularly, PEX-A is formed of a polyethylene having peroxide incorporated therein. Upon heating the peroxide polyethylene above the decomposition temperature of the peroxide, “free” radicals are produced to initiate the cross-linking process. PEX-B is formed by using silane to cross-link polyethylene. PEX-B is formed by using silane-grafted polyethylene which is then “moisture-cured” by exposure to heat and water, also known as sauna curing. PEX-C is formed of polyethylene which is cross-linked by bombarding it with electromagnetic (gamma) or high energy electron (beta) radiation.

According to an exemplary embodiment of the present disclosure, the overmolded waterway assembly 50 is passed under a radiation unit to cause cross-linking. It is within the scope of the present disclosure that individual components of waterway assembly 50 may be cross-linked before assembly. For example, collar 52, tubes 12, 14, 16, and/or nipples 70, 72, 74, may be cross-linked before assembly. It is also within the scope of the present disclosure that individual components of waterway assembly 50 may be cross-linked both before and after assembly. For example, the material for collar 52 may be partially cross-linked before overmolding, and collar 52 may be further cross-linked after overmolding.

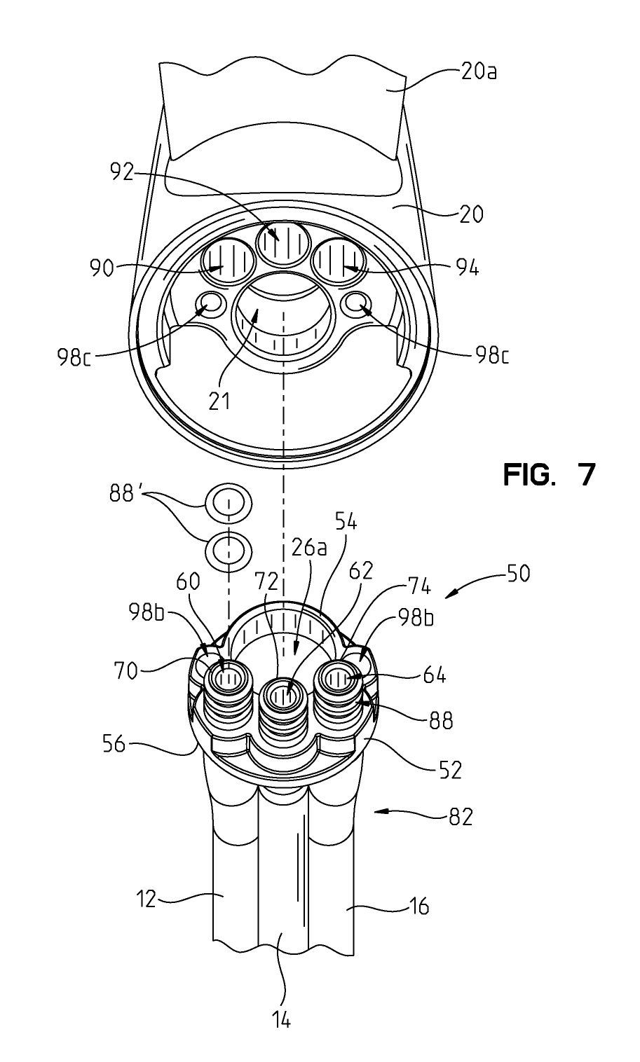

With further reference to FIGS. 2-7, waterway assembly 50 may be secured within hub 20 of faucet 10. For example, in the illustrated embodiment, faucet 10 includes mounting plate 96 and at least one fastener, such as screws 98. With mounting plate 96 positioned beneath collar 52 of waterway assembly 50, screws 98 may extend upwardly through apertures 98a defined in mounting plate 96, through corresponding apertures 98b defined in collar 52 of waterway assembly 50, and into corresponding apertures 98c defined in hub 20, as shown in FIGS. 2 and 7.

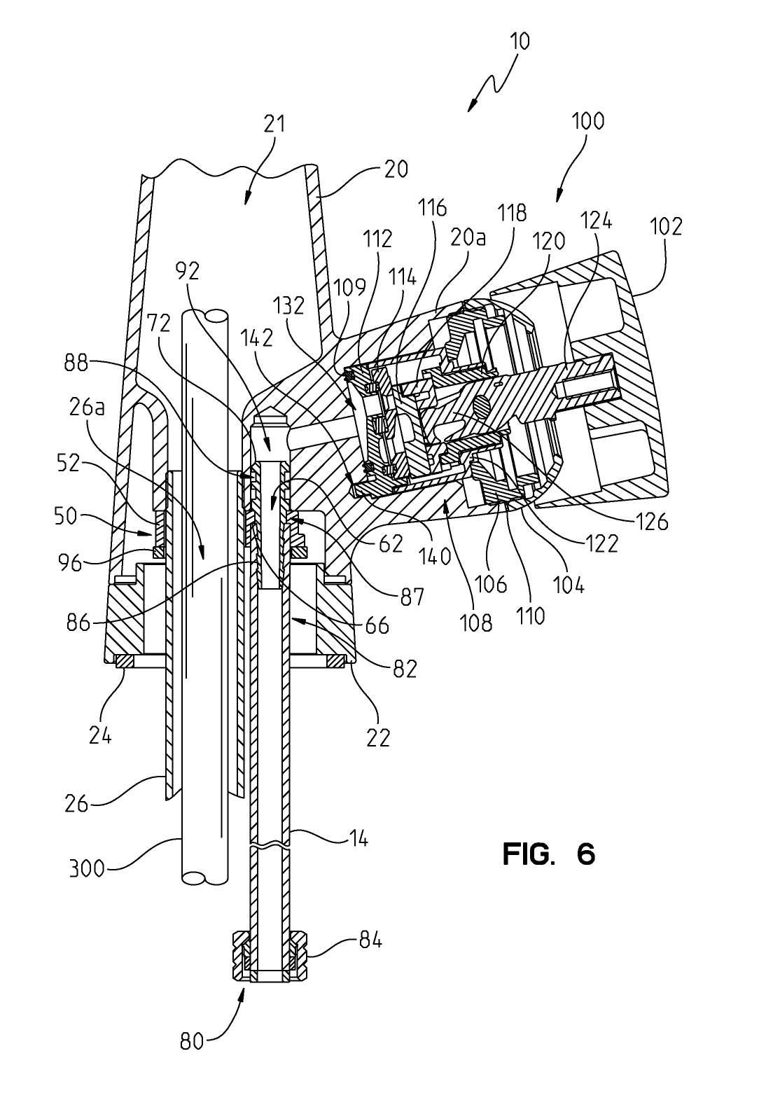

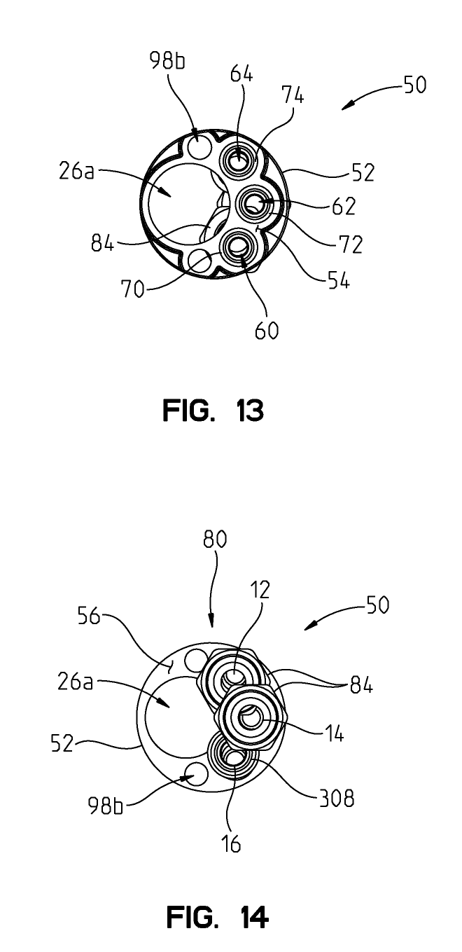

In an illustrative embodiment, collar 52 of waterway assembly 50 may define aperture 26a that is configured to accommodate mounting shank 26 in hub 20. As shown in FIGS. 13 and 14, aperture 26a extends through collar 52 from upper surface 54 to lower surface 56. With waterway assembly 50 secured to hub 20, mounting shank 26 may extend downwardly from hub 20 and through aperture 26a in collar 52, as shown in FIG. 6.

Referring next to FIGS. 4-7 and 15, hub 20 of faucet 10 defines hot water inlet chamber 90, cold water inlet chamber 92, and outlet chamber 94. In the illustrated embodiment, with waterway assembly 50 secured to hub 20, hot water inlet nipple 70 of waterway assembly 50 is received within hot water inlet chamber 90 of hub 20, cold water inlet nipple 72 of waterway assembly 50 is received within cold water inlet chamber 92 of hub 20, and outlet nipple 74 of waterway assembly 50 is received within outlet chamber 94 of hub 20, as shown in FIG. 7. Each nipple 70, 72, 74, may define external annular grooves 88 that are configured to receive sealing rings, illustratively O-rings 88′, to resist leakage between hub 20 and waterway assembly 50.

With reference to FIGS. 1-7 and 15, a flow directing member, illustratively valve assembly 100, is supported by hub 20 of faucet 10. More particularly, valve assembly 100 is supported by valve portion 20a of hub 20 of faucet 10. The illustrative valve assembly 100 of FIG. 2 includes handle 102, bonnet 104, nut 106, valve body 108, seal 109, and temperature indicator 110. Handle 102 may be movably coupled to bonnet 104 using suitable fasteners 103, such as those fasteners illustrated in FIG. 2. Bonnet 104 and nut 106 may be configured to couple valve body 108 to valve portion 20a of hub 20. For example, nut 106 may be configured to threadably engage valve portion 20a of hub 20, and bonnet 104 may be configured to extend over valve body 108 and threadably engage nut 106, as shown in FIG. 6. With seal 109 positioned between valve body 108 and valve portion 20a of hub 20, as shown in FIG. 6, a leak-resistant coupling may be achieved between valve assembly 100 and hub 20.

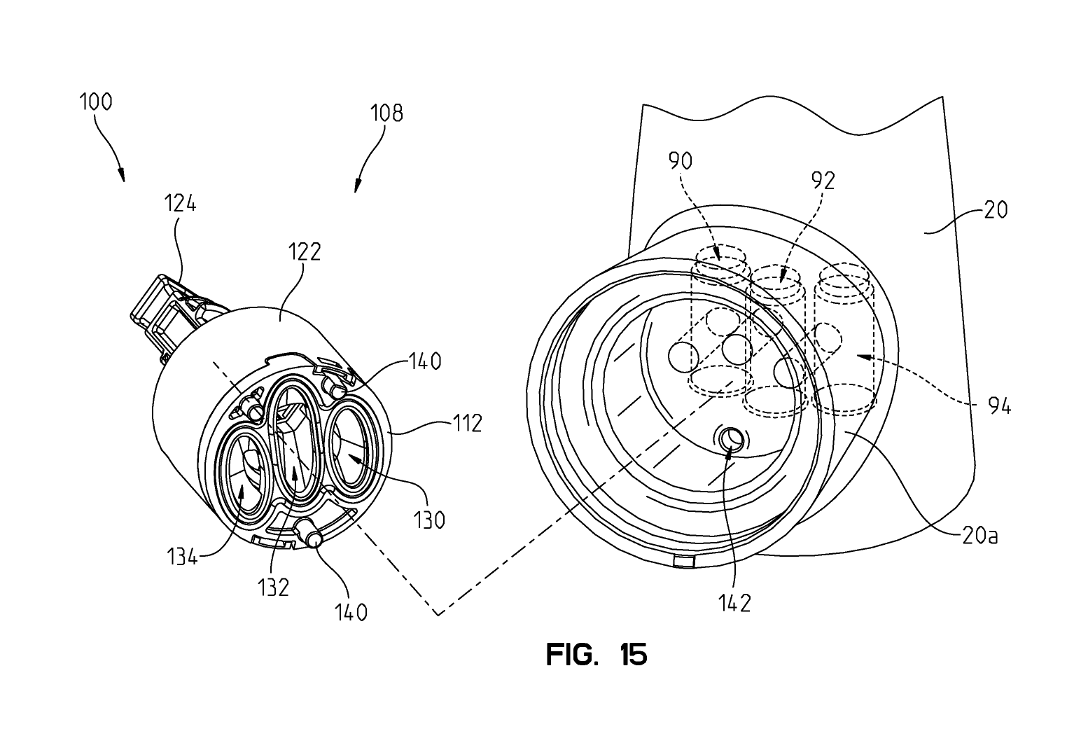

With further reference to FIGS. 6 and 15, valve body 108 of the illustrative valve assembly 100 includes lower housing 112, lower disc 114, upper disc 116, carrier 118, coupling member 120, upper housing 122, and stem 124 having extension 126. As shown in FIG. 15, valve body 108 of valve assembly 100 also includes hot water inlet port 130, cold water inlet port 132, and outlet port 134. In the illustrative embodiment, hot water inlet port 130 of valve assembly 100 is arranged in fluid communication with hot water inlet chamber 90 of hub 20, cold water inlet port 132 of valve assembly 100 is arranged in fluid communication with cold water inlet chamber 92 of hub 20, and outlet port 134 of valve assembly 100 is arranged in fluid communication with outlet chamber 94 of hub 20, as shown in FIG. 15.

One or more first locating elements, illustratively pegs 140 of FIG. 15, extend from valve assembly 100 to assist with coupling valve assembly 100 to valve portion 20a of hub 20. More particularly, pegs 140 may extend from lower housing 112 of valve assembly 100. The first locating elements of valve assembly 100 are configured to couple to corresponding second locating elements of hub 20, illustratively recesses 142 of FIG. 15. Each recess 142 may be formed within valve portion 20a of hub 20 to receive peg 140. Positioning each peg 140 within a corresponding recess 142 may facilitate proper orientation of valve assembly 100 relative to hub 20, and as a result, proper orientation of valve assembly 100 relative to waterway assembly 50. More particularly, positioning peg 140 within recess 142 may facilitate proper orientation of tubes 12, 14, 16, and nipples 70, 72, 74, of waterway assembly 50, chambers 90, 92, 94, of hub 20, and ports 130, 132, 134, of valve assembly 100, respectively. Also, positioning peg 140 within recess 142 may improve resistance to torque generated between hub 20, waterway assembly 50, and valve assembly 100. With peg 140 of valve body 108 received within recess 142 of hub 20, seal 109 may be positioned between valve body 108 and hub 20 to resist leakage between the components, as discussed above and as illustrated in FIG. 6.

According to an exemplary embodiment of the present disclosure, valve assembly 100 is oriented non-parallel, and illustratively substantially transverse, to waterway assembly 50. As shown in FIGS. 6 and 15, chambers 90, 92, 94, of hub 20, are substantially bent or L-shaped to fluidly couple a generally vertically positioned waterway assembly 50 to a generally horizontally positioned valve assembly 100. It is also within the scope of the present disclosure that valve assembly 100 may be located above and substantially parallel to waterway assembly 50 in certain embodiments.

In use, the illustrative valve assembly 100 may be operated by adjusting handle 102. Adjusting handle 102 actuates stem 124 of valve body 108, and extension 126 transmits the motion of stem 124 to upper disc 116 via carrier 118. As shown in FIG. 6, upper disc 116 is positioned adjacent to lower disc 114 to control the mixing of hot and cold water and the flow rate of water through valve assembly 100. Illustratively, both upper disc 116 and lower disc 114 are constructed of a ceramic material or another suitable material, such as stainless steel. Therefore, by adjusting handle 102 and moving upper disc 116 relative to lower disc 114, a user is able to selectively vary the temperature and flow rate of water supplied to outlet port 134 of valve body 108 via hot water inlet port 130 and cold water inlet port 132 of valve body 108 (FIG. 15). Because waterway assembly 50 is in fluid communication with valve body 108, adjusting handle 102 allows a user to selectively vary the temperature and flow rate of water supplied to outlet tube 16 of waterway assembly 50 from hot water inlet tube 12 and cold water inlet tube 14 via chambers 90, 92, 94, of hub 20 and nipples 70, 72, 74, of waterway assembly 50, respectively.

Additional details of an illustrative valve assembly are provided in U.S. Patent Publication No. 2007/0271695 to Thomas et al., filed Jan. 31, 2007, entitled “FAUCET INCLUDING A MOLDED WATERWAY ASSEMBLY,” the disclosure of which is expressly incorporated by reference herein. While the illustrative valve assembly 100 is of a movable disc variety, it should be appreciated that other types of valve assemblies may be substituted therefor. For example, a ball-type mixing valve assembly may find equal applicability with the present invention. Illustrative ball-type valve assemblies are detailed in U.S. Pat. No. 4,838,304 to Knapp, U.S. Pat. No. 5,615,709 to Knapp, U.S. Pat. No. 5,927,333 to Grassberger, and U.S. Pat. No. 6,920,899 to Haenlein et al., the disclosures of which are expressly incorporated by reference herein.

As discussed above, hot and cold water flows from hot and cold water supplies (not shown) to valve assembly 100 of faucet 10. More particularly, hot water flows from the hot water supply (not shown) to hot water inlet port 130 of valve assembly 100 via hot water inlet tube 12, hot water inlet nipple 70, and hot water inlet chamber 90. Similarly, cold water flows from the cold water supply (not shown) to cold water inlet port 132 of valve assembly 100 via cold water inlet tube 14, cold water inlet nipple 72, and cold water inlet chamber 92. In valve assembly 100, the hot and cold inlet water streams are mixed and redirected. The mixed or outlet water stream flows from outlet port 134 of valve assembly 100 to outlet tube 16 via outlet chamber 94 and outlet nipple 74.

Referring to FIGS. 1-3 and 6, faucet 10 may further include spout assembly 200 configured to dispense the outlet water stream. Spout assembly 200 is supported by hub 20 of faucet 10. More particularly, spout assembly 200 is supported by spout portion 20b of hub 20 of faucet 10. The illustrative spout assembly 200 includes sleeve 202, spacer 204, and spout tube 206 defining an internal spout chamber (not shown). Spout tube 206 may be configured to receive a pull-out wand 210. Faucet 10 may include a suitable retainer, such as clip 212, to detachably couple wand 210 to spout tube 206.

In one illustrative embodiment, components of spout assembly 200, including spout tube 206 of spout assembly 200, are formed of a non-metallic material. More particularly, spout assembly 200 of faucet 10 may be molded from a polymer, such as a thermoplastic or a cross-linkable material, and illustratively a cross-linkable polyethylene (PEX). Further illustrative non-metallic materials include polybutylene terephthalate (PBT) and thermosets, such as polyesters, melamine, melamine urea, melamine phenolic, and phenolic. It is also within the scope of the present disclosure that spout assembly 200 of faucet 10 may be formed of a traditional metallic material, such as zinc or brass. Additional details of a further illustrative embodiment spout is disclosed in U.S. Patent Publication No. 2008/0178954 to Pinette et al., filed Jan. 31, 2007, entitled “SPOUT TIP ATTACHMENT,” the disclosure of which is expressly incorporated by reference herein.

Referring to FIG. 2, the illustrative faucet 10 further includes outlet hose 300 that may be fluidly coupled to outlet tube 16. Outlet hose 300 extends between first, inlet end 302 and second, discharge end 304. In the illustrated embodiment, inlet end 302 of outlet hose 300 is fluidly coupled to first end 80 of outlet tube 16. Faucet 10 may include a suitable fastener, such as clip 306, that is configured to fluidly couple inlet end 302 of outlet hose 300 to first end 80 of outlet tube 16. For example, first end 80 of outlet tube 16 may include an overmolded coupling 308 (FIG. 8) that is configured to fluidly couple to clip 306, and, similarly, inlet end 302 of outlet hose 300 may be configured to fluidly couple to clip 306. Coupling 308 of outlet tube 16 may define external annular grooves 310 that are configured to receive sealing rings, such as O-rings (not shown), to reduce leakage between outlet tube 16 and clip 306.

According to an exemplary embodiment of the present disclosure, faucet 10 may be assembled by fluidly coupling discharge end 304 of outlet hose 300 to spout assembly 200, and in particular to wand 210 of spout assembly 200. Discharge end 304 of outlet hose 300 may include an overmolded coupling 312, similar to coupling 308 described above, that is configured to fluidly couple outlet hose 300 to spout assembly 200. Like coupling 308 of outlet tube 16, coupling 312 of outlet hose 300 may be configured to receive sealing rings, such as O-rings (not shown), to reduce leakage between outlet hose 300 and spout assembly 200.

After coupling discharge end 304 of outlet hose 300 to spout assembly 200, inlet end 302 of outlet hose 300 may be inserted through the internal chamber (not shown) of spout tube 206, downwardly through internal chamber 21 of hub 20, and downwardly through mounting shank 26, which extends through aperture 26a of collar 52, as mentioned above. In this arrangement, spout tube 206 and hub 20 may conceal outlet hose 300 from the view of an outside observer. To facilitate insertion of outlet hose 300 through spout tube 206, hub 20, and mounting shank 26, faucet 10 may be provided with an insertion device, illustratively lead 316 of FIG. 2. Lead 316 may be coupled to inlet end 302 of outlet hose 300 during insertion, and lead 316 may be removed from inlet end 302 of outlet hose 300 after insertion in order to fluidly couple outlet hose 300 to outlet tube 16.

Referring to FIGS. 1 and 2, with outlet hose 300 fluidly coupled to outlet tube 16 using clip 306, for example, the mixed water stream flows from outlet port 134 of valve assembly 100, downwardly through outlet tube 16 of waterway assembly 50, and upwardly through outlet hose 300 that extends through mounting shank 26, hub 20, and spout tube 206. Then, the mixed water stream is delivered from wand 210 of spout assembly 200 into sink basin 19, for example.

Although the invention has been described in detail with reference to certain preferred embodiments, variations and modifications exist within the spirit and scope of the invention as described and defined in the following claims.

1. A fluid delivery device comprising:
a waterway assembly comprising:
an inlet fluid transport component formed of a polymer and extending between opposing first and second ends;
an inlet nipple formed of a polymer and fluidly coupled to the second end of the inlet fluid transport component;
an outlet fluid transport component formed of a polymer and extending between opposing first and second ends;
an outlet nipple formed of a polymer and fluidly coupled to the second end of the outlet fluid transport component; and
a collar formed of a polymer and having an upper surface and a lower surface, the collar being coupled to the inlet fluid transport component, the inlet nipple, the outlet fluid transport component, and the outlet nipple; and
a valve assembly comprising:
an inlet port in fluid communication with the inlet nipple;
an outlet port in fluid communication with the outlet nipple; and
a movable valve member configured to control the flow of water from the inlet port to the outlet port.

2. The fluid delivery device of claim 1, wherein the collar is overmolded around the inlet fluid transport component, the inlet nipple, the outlet fluid transport component, and the outlet nipple.

3. The fluid delivery device of claim 1, wherein the waterway assembly extends generally vertically and the valve assembly extends generally horizontally.

4. The fluid delivery device of claim 1, wherein the valve assembly extends transverse to the waterway assembly.

5. The fluid delivery device of claim 1, wherein the inlet nipple and the outlet nipple project upwardly above the upper surface of the collar.

6. The fluid delivery device of claim 1, wherein the inlet fluid transport component and the outlet fluid transport component project downwardly below the lower surface of the collar.

7. The fluid delivery device of claim 1, wherein the inlet fluid transport component, the inlet nipple, the outlet fluid transport component, the outlet nipple, and the collar are formed of polyethylene.

8. The fluid delivery device of claim 1, further comprising a hub fluidly coupled to the waterway assembly and to the valve assembly.

9. The fluid delivery device of claim 8, further comprising a mounting member configured to secure the collar of the waterway assembly to the hub.

10. The fluid delivery device of claim 8, wherein the hub is formed of a polymer.

11. The fluid delivery device of claim 8, wherein the hub defines an inlet chamber and an outlet chamber that extend between the waterway assembly and the valve assembly.

12. The fluid delivery device of claim 11, wherein the inlet chamber and the outlet chamber of the hub are generally L-shaped.

13. The fluid delivery device of claim 8, further comprising a securing member that extends downwardly from the hub, the securing member configured to secure the hub to a sink deck.

14. The fluid delivery device of claim 1, further comprising:
a second inlet fluid transport component formed of a polymer and extending between opposing first and second ends; and
an second inlet nipple fluidly coupled to the second end of the second inlet fluid transport component, the collar being overmolded around the second inlet fluid transport component and the second inlet nipple.

15. A faucet comprising:
a hub;
a waterway assembly fluidly coupled to the hub, the waterway assembly comprising:
a non-metallic collar;
a non-metallic hot water inlet tube having a first end configured to be fluidly coupled to a hot water supply and a second end operably coupled to the collar;
a non-metallic hot water inlet nipple fluidly coupled to the second end of the hot water inlet tube;
a non-metallic cold water inlet tube having a first end configured to be fluidly coupled to a cold water supply and a second end operably coupled to the collar;
a non-metallic cold water inlet nipple fluidly coupled to the second end of the cold water inlet tube;
a non-metallic outlet tube extending between opposing first and second ends, the second end operably coupled to the collar; and
a non-metallic outlet nipple fluidly coupled to the second end of the outlet tube; and
a valve assembly fluidly coupled to the hub, the valve assembly comprising:
a hot water inlet port in fluid communication with the hot water inlet nipple;
a cold water inlet port in fluid communication with the cold water inlet nipple;
an outlet port in fluid communication with the outlet nipple; and
a movable valve member configured to control the flow of water from the hot water inlet port and the cold water inlet port to the outlet port.

16. The faucet of claim 15, wherein the collar is overmolded around the hot water inlet tube, the hot water inlet nipple, the cold water inlet tube, the cold water inlet nipple, the outlet tube, and the outlet nipple.

17. The faucet of claim 15, wherein the valve assembly extends transverse to the waterway assembly.

18. The faucet of claim 15, wherein the collar, the hot water inlet tube, the hot water inlet nipple, the cold water inlet tube, the cold water inlet nipple, the outlet tube, and the outlet nipple are formed of polyethylene.

19. The faucet of claim 15, further comprising a spout assembly and an outlet hose coupled to the first end of the outlet tube, the outlet hose extending through the spout assembly.

20. The faucet of claim 15, wherein the hub is formed of a polymer.

21. The faucet of claim 15, wherein the hub defines a hot water inlet chamber, a cold water inlet chamber, and an outlet chamber that extend between the waterway assembly and the valve assembly.

22. The faucet of claim 21, wherein the hot water inlet chamber, the cold water inlet chamber, and the outlet chamber of the hub are generally L-shaped.

23. A waterway assembly comprising:
a plurality of tubes formed of a polymer and extending between opposing first and second ends;
a plurality of nipples formed of a polymer and fluidly coupled to the second ends of the plurality of tubes; and
a collar formed of a polymer and having an upper surface and a lower surface, the collar being coupled to the second ends of the plurality of tubes and the plurality of nipples.

24. The waterway assembly of claim 23, wherein the collar is overmolded around the second ends of the plurality of tubes and the plurality of nipples.

25. The waterway assembly of claim 23, wherein the plurality of tubes, the plurality of nipples, and the collar are formed of polyethylene.

26. The waterway assembly of claim 23, wherein the plurality of nipples project upwardly above the upper surface of the collar.

27. The waterway assembly of claim 23, wherein the plurality of tubes project downwardly below the lower surface of the collar.

28. The waterway assembly of claim 23, wherein the collar includes a plurality of spaced-apart openings formed around the second ends of the plurality of tubes.

29. The waterway assembly of claim 23, wherein the plurality of tubes are flexible.

30. The waterway assembly of claim 23, wherein the first ends of the plurality of tubes are free to move relative to the collar.

31. The waterway assembly of claim 23, wherein each of the plurality of nipples extends into the second end of a corresponding tube, each of the plurality of nipples including a barbed exterior surface that engages an inner surface of the corresponding tube.
